(19) United States
(12) Patent Application Publication
(10) Pub. No.: US 2019/0333293 A1
(43) Pub. Date: Oct. 31, 2019

(54) ON-BOARD DIAGNOSTICS SENSOR CONTROLLED REACTIVE SYSTEM AND METHODS OF USE THEREOF

(71) Applicants: Christian Theodore LOMASCOLO, Mooresville, NC (US); Thomas John LOMASCOLO, Mooresville, NC (US)

(72) Inventors: Christian Theodore LOMASCOLO, Mooresville, NC (US); Thomas John LOMASCOLO, Mooresville, NC (US)

(21) Appl. No.: 15/964,860

(22) Filed: Apr. 27, 2018

(51) Int. Cl. G07C 5/08; H04W 4/40

(52) U.S. Cl. CPC G07C 5/0808; H04W 4/40

(57) ABSTRACT

On-Board Diagnostics (“OBD”) sensor controlled reactive system include a vehicle communication device and a reactive device. The vehicle communication device is configured to read vehicle parameters of a vehicle from an OBD port of the vehicle or from a direct link directly from the on-board computer of the vehicle. The reactive device is in communication with the vehicle communication device. The reactive device is configured to process data of the read vehicle parameters of the vehicle from the vehicle communication device. Wherein, the reactive device is configured to be controlled by the processed data of the read vehicle parameters of the vehicle from the vehicle communication device from the OBD port of the vehicle.

### FIELD OF THE DISCLOSURE

The present disclosure is directed to accessories for vehicles. More specifically, the instant disclosure is directed to an on-board diagnostics (“OBD”) sensor controlled reactive system for vehicles and methods of use thereof.

### BACKGROUND OF THE DISCLOSURE

On-Board Diagnostics of a vehicle, also known as “OBD”, is an automotive term referring to a vehicle's self-diagnostic and reporting capability. OBD systems give the vehicle owner or repair technician access to the status of the various vehicle subsystems. The amount of diagnostic information available via OBD has varied widely since its introduction in the early 1980s versions of on-board vehicle computers. Early versions of OBD would simply illuminate a malfunction indicator light if a problem was detected but would not provide any information as to the nature of the problem. Current OBD systems use a standardized digital communications port to provide real-time data in addition to a standardized series of diagnostic trouble codes, or DTCs, which allow one to quickly and easily identify and remedy malfunctions within the vehicle.

Currently, the most widely used OBD standard is the OBD-II standard. The OBD-II standard specifies the type of diagnostic connector and its pinout, the electrical signalling protocols available, and the messaging format. It also provides a candidate list of vehicle parameters to monitor along with how to encode the data for each, like engine rpm, temperature, vehicle speed, etc. There is a pin in the connector that provides power for the scan tool from the vehicle battery, which eliminates the need to connect a scan tool to a power source separately. However, some technicians might still connect the scan tool to an auxiliary power source to protect data in the unusual event that a vehicle experiences a loss of electrical power due to a malfunction. Finally, the OBD-II standard provides a list of standardized diagnostic trouble codes, or DTCs. As a result of this OBD-II standardization, a single device can query the on-board computer(s) for these parameters in real-time for any vehicle. OBD-II standardization was prompted to simplify diagnosis of increasingly complicated emissions equipment, and though only emission-related codes and data are required to be transmitted through it, according to U.S. legislation, most manufacturers have made the OBD-II Data Link Connector the main connector in the vehicle through which all systems are diagnosed and reprogrammed. OBD-II Diagnostic Trouble Codes are 4-digit, preceded by a letter: P for engine and transmission (powertrain), B for body, C for chassis, and U for network. Manufacturers may also add custom data parameters to their specific OBD-II implementation, including real-time data requests as well as trouble codes.

The SAE J1962 specification provides for two standardized hardware interfaces, called type A and type B connections or plug receptacles. Both are female, 16-pin (2×8), D-shaped connectors, and both have a groove between the two rows of pins, type B having a groove interrupted in the middle. This prohibits the insertion of a type A male plug while still allowing a type B male plug to be inserted into a type A female socket. The type A connector is used for vehicles that use 12V supply voltage, whereas type B is used for 24V vehicles and it is required to mark the front of the D-shaped area in blue color. Unlike the OBD-I connector, which was sometimes found under the hood of the vehicle, the OBD-II connector is required to be within 2 feet (0.61 m) of the steering wheel (unless an exemption is applied for by the manufacturer, in which case it is still somewhere within reach of the driver).

Prior to the instant disclosure, the real-time vehicle parameters of a vehicle have never been known to be used for controlling reactive lighting in or on a vehicle. As such, the instant disclosure may be directed toward the discovery that real-time vehicle parameters, like engine rpm, temperature, speed of the vehicle, etc., may be used to control reactive lighting in or on a vehicle via the On-Board Diagnostics of the vehicle, like via the OBD-II port of the vehicle. This discovery of real-time vehicle parameters being useful for controlling reactive lighting in or on a vehicle may be used for safety as well as cosmetic needs or desires.

The instant disclosure is designed to address at least certain aspects of the problems or needs discussed above by providing the instant OBD sensor controlled reactive system and methods of use thereof.

### SUMMARY

Accordingly, in one aspect, the present disclosure embraces an On-Board Diagnostics (“OBD”) sensor controlled reactive system. The OBD sensor controlled reactive system may include a vehicle communication device and a reactive device. The vehicle communication device may be configured to read vehicle parameters of a vehicle. The reactive device may be in communication with the vehicle communication device. The reactive device may be configured to process data of the read vehicle parameters of the vehicle from the vehicle communication device. Wherein, the reactive device may be configured to be controlled by the processed data from the read vehicle parameters of the vehicle from the vehicle communication device.

In select embodiments, the vehicle communication device may be an OBD serial communication device configured to read vehicle parameters of the vehicle from the OBD port of the vehicle.

In other select embodiments, the vehicle communication device may be configured to read vehicle parameters of the vehicle via a direct link to the on-board computer of the vehicle.

In select embodiments of the instant OBD sensor controlled reactive system, a first digital communication device and a second digital communication device may be included. The first digital communication device may be included with the vehicle communication device. The second digital communication device may be included with the reactive device. The first digital communication device may be configured to communication with the second digital communication device. Wherein, the reactive device may be configured to be controlled by the processed data of the read vehicle parameters of the vehicle from the vehicle communication device from the OBD port of the vehicle via communication between the first digital communication device and the second digital communication device. In select embodiments, the first digital communication device may be configured to communicate wirelessly with the second digital communication device via a first wireless communication. As an example, and clearly not limited thereto, the first digital communication device may be configured to communicate wirelessly with the second digital communication device, where the first wireless communication may be short-wavelength UHF radio waves in the ISM band from 2.4 to 2.485 GHz (i.e. Bluetooth® wireless communication).

One feature of the OBD sensor controlled reactive system of the instant disclosure may be the inclusion of a user interface. The user interface may be configured to allow a user to program the reactive device to be configured to be reactive with various patterns based on the processed data of the various read vehicle parameters of the vehicle from the vehicle communication device from the OBD port of the vehicle. The user interface may include a third digital communication device. This third digital communication device may be configured to communicate with the reactive device. The third digital communication device may be configured for programming the reactive device. In select embodiments, the third digital communication device may be configured to communicate wirelessly with the second digital communication device of the reactive device via a second wireless communication. As an example, and clearly not limited thereto, the third digital communication device may be configured to communicate wirelessly with the second digital communication device via the second wireless communication, where the second wireless communication may be short-wavelength UHF radio waves in the ISM band from 2.4 to 2.485 GHz (i.e. Bluetooth® wireless communication).

Another feature of the OBD sensor controlled reactive system of the instant disclosure may be that the user interface may include a mobile application. The mobile application may be configured to be operated on a mobile device. Wherein, the third digital communication device may be the mobile device or built into the mobile device.

In select embodiments of the OBD sensor controlled reactive system of the instant disclosure, the reactive device may include a circuit board. The circuit board may be built into the reactive device or it may be external to the reactive device. The circuit board of the reactive device may be configured for controlling lights of the reactive device based on the processed data of the read vehicle parameters of the vehicle from the vehicle communication device from the OBD port of the vehicle. In select embodiments, the circuit board may include a power regulator configured to power the lights of the reactive device. As examples, and clearly not limited thereto, the power regulator may include a wired dc power source (to the car battery) or an independent battery power source.

In select embodiments of the OBD sensor controlled reactive system, the circuit board may include a micro-controller configured to control the lights of the reactive device.

In select embodiments of the OBD sensor controlled reactive system, the lights of the reactive device may include light emitting diode lights.

In select embodiments of the OBD sensor controlled reactive system, the vehicle parameters read by the vehicle communication device may include, but are clearly not limited thereto, real time vehicle parameters, including, an engine rpm, a temperature, a vehicle speed, and combinations thereof. In these select embodiments, the reactive device may be configured to be controlled by, or react based upon, the engine rpm, the temperature, the vehicle speed, the like, other real time vehicle parameters, and combinations thereof.

In select embodiments of the OBD sensor controlled reactive system, the reactive device may be a strip LED configured to be controlled by, or react based upon, the engine rpm, the temperature, the vehicle speed, and combinations thereof.

In select embodiments of the OBD sensor controlled reactive system, the reactive device may be a halo LED configured to be controlled by, or react based upon, the engine rpm, the temperature, the vehicle speed, and combinations thereof.

In select embodiments of the OBD sensor controlled reactive system, the reactive device may be a strip LED positioned around the hood of the vehicle configured to be controlled by, or react based upon, the engine rpm, the temperature, the vehicle speed, and combinations thereof.

In select embodiments of the OBD sensor controlled reactive system, the reactive device may be a halo LED positioned around the headlights of the vehicle and configured to be controlled by, or react based upon, the engine rpm, the temperature, the vehicle speed, and combinations thereof.

In select embodiments of the OBD sensor controlled reactive system, the reactive device may be brake lights configured to be controlled by, or react based upon, the vehicle speed, where the brake lights react when the vehicle speed decreases.

In select embodiments of the OBD sensor controlled reactive system, the reactive device may be reverse lights configured to be controlled by, or react based upon, the vehicle speed, where the reverse lights react when the vehicle speed is negative.

In select embodiments of the OBD sensor controlled reactive system, the reactive device may be headlights of the vehicle and configured to be controlled by, or react based upon, the engine rpm, the temperature, the vehicle speed, and combinations thereof.

In select embodiments of the OBD sensor controlled reactive system, the reactive device may be fog lights of the vehicle and configured to be controlled by, or react based upon, the engine rpm, the temperature, the vehicle speed, and combinations thereof.

In select embodiments of the OBD sensor controlled reactive system, the reactive device may be signal lights of the vehicle and configured to be controlled by, or react based upon, the engine rpm, the temperature, the vehicle speed, and combinations thereof.

In select embodiments of the OBD sensor controlled reactive system, the reactive device may be interior lights positioned inside the vehicle and configured to be controlled by, or react based upon, the engine rpm, the temperature, the vehicle speed, and combinations thereof.

In another aspect, the instant disclosure embraces a method of controlling lights of a vehicle based on the instant on-board diagnostics sensor controlled reactive system. Accordingly, the instant method of controlling lights of a vehicle may include the step of providing the instant on-board diagnostics sensor controlled reactive system in any of the various embodiments shown and/or described herein. As such, the OBD sensor controlled reactive system provided in the instant method of controlling lights of a vehicle may generally include the vehicle communication device configured to read real-time vehicle parameters of the vehicle from the OBD port of the vehicle, and the reactive device in communication with the vehicle communication device, where the reactive device may be configured to process data of the read vehicle parameters of the vehicle from the vehicle communication device. The instant method of controlling lights of a vehicle based on the instant on-board diagnostics sensor controlled reactive system may then include the step of controlling the reactive device based on the processed data of the read vehicle parameters of the vehicle from the vehicle communication device from the OBD port of the vehicle.

In select embodiments of the instant method of controlling lights of a vehicle based on the instant on-board diagnostics sensor controlled reactive system, when the OBD sensor controlled reactive system includes the user interface, where the user interface is configured to allow a user to program the reactive device to be configured to be reactive with various patterns based on the processed data of the various read vehicle parameters of the vehicle from the vehicle communication device from the OBD port of the vehicle, wherein the user interface includes a third digital communication device configured to communicate with the reactive device configured for programming the reactive device, wherein the third digital communication device is configured to communicate wirelessly with the second digital communication device of the reactive device, and wherein the user interface includes a mobile application configured to be operated on a mobile device, wherein the third digital communication device is the mobile device, the method may further include the step of programming the reactive device via the user interface on the mobile device.

In select embodiments, the instant method of controlling lights of a vehicle may include the steps of programming a strip LED, a halo LED, a brake light, a reverse light, a headlight, a fog light, a signal light, an interior light, or combinations thereof, based on the engine rpm, the temperature, the vehicle speed, and combinations thereof and the step of controlling the strip LED, the halo LED, the brake light, the reverse light, the headlight, the fog light, the signal light, the interior light, or combinations thereof based on the engine rpm, the temperature, the vehicle speed, and combinations thereof.

The foregoing illustrative summary, as well as other exemplary objectives and/or advantages of the invention, and the manner in which the same are accomplished, are further explained within the following detailed description and its accompanying drawings.

### BRIEF DESCRIPTION OF THE DRAWINGS

The present apparatuses, systems and methods will be better understood by reading the Detailed Description with reference to the accompanying drawings, which are not necessarily drawn to scale, and in which like reference numerals denote similar structure and refer to like elements throughout, and in which:

FIG. 1 is a schematic flow diagram of the instant on-board diagnostics sensor controlled reactive system according to select embodiments of the instant disclosure;

FIG. 2A is a top perspective view of the strip LED lights for use in the instant on-board diagnostics sensor controlled reactive system according to select embodiments of the instant disclosure;

FIG. 2B is a top perspective view of the strip LED lights from FIG. 2A showing the LED lights lit up in a pattern according to select embodiments of the instant disclosure;

FIG. 3A is a top view of the halo LED lights for use in the instant on-board diagnostics sensor controlled reactive system according to select embodiments of the instant disclosure;

FIG. 3B is a top view of the halo LED lights from FIG. 3A showing the LED lights lit up in a pattern according to select embodiments of the instant disclosure;

FIG. 3C is a perspective view of the halo LED lights from FIG. 3A;

FIG. 5 is a top view of the circuit board of the reactive lights source for use in the instant on-board diagnostics sensor controlled reactive system according to select embodiments of the instant disclosure;

FIG. 6 is a front view of the mobile device with the mobile application and user interface for use in the instant on-board diagnostics sensor controlled reactive system according to select embodiments of the instant disclosure;

FIG. 7A is a front perspective view of a vehicle showing various embodiments and locations of the instant on-board diagnostics sensor controlled reactive system according to select embodiments of the instant disclosure;

FIG. 7B is a front perspective view of the vehicle from FIG. 7A showing the lights of the various reactive devices lit up in a pattern according to select embodiments of the instant disclosure

FIGS. 8A and 8B are split schematic views of a circuit diagram for the circuit board of the reactive device for use in the instant on-board diagnostics sensor controlled reactive system according to select embodiments of the instant disclosure;

FIG. 9 is a schematic view of a circuit diagram for the circuit board of the reactive device for use in the instant on-board diagnostics sensor controlled reactive system according to select embodiments of the instant disclosure;

FIG. 10 is a schematic view of a circuit diagram for the circuit board of the reactive device for use in the instant on-board diagnostics sensor controlled reactive system according to select embodiments of the instant disclosure;

FIGS. 11A and 11B are split schematic views of a circuit diagram for the circuit board of the reactive device for use in the instant on-board diagnostics sensor controlled reactive system according to select embodiments of the instant disclosure;

FIG. 12 is a schematic view of a circuit diagram for the circuit board of the reactive device for use in the instant on-board diagnostics sensor controlled reactive system according to select embodiments of the instant disclosure;

FIG. 13 is a schematic view of a circuit diagram for the circuit board of the reactive device for use in the instant on-board diagnostics sensor controlled reactive system according to select embodiments of the instant disclosure;

FIG. 14 is a schematic view of a circuit diagram for the circuit board of the reactive device for use in the instant on-board diagnostics sensor controlled reactive system according to select embodiments of the instant disclosure; and

FIG. 15 is a flow diagram of the method of controlling lights of a vehicle according to select embodiments of the instant disclosure.

It is to be noted that the drawings presented are intended solely for the purpose of illustration and that they are, therefore, neither desired nor intended to limit the disclosure to any or all of the exact details of construction shown, except insofar as they may be deemed essential to the claimed disclosure.

### DETAILED DESCRIPTION

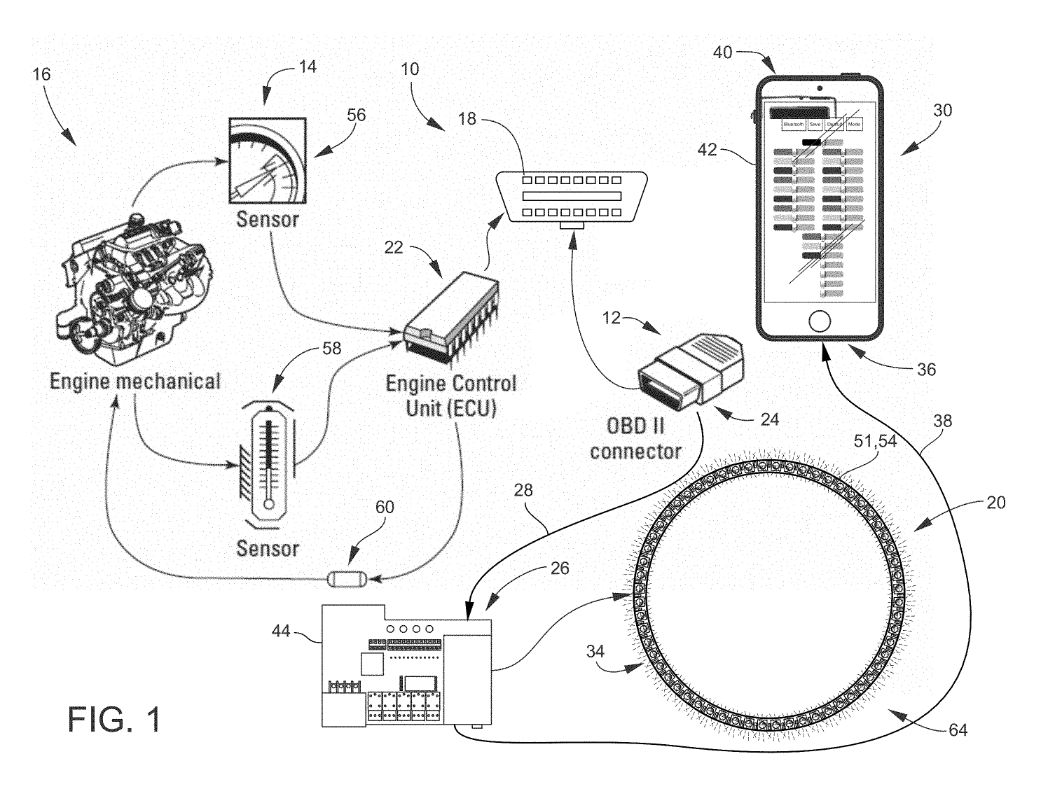

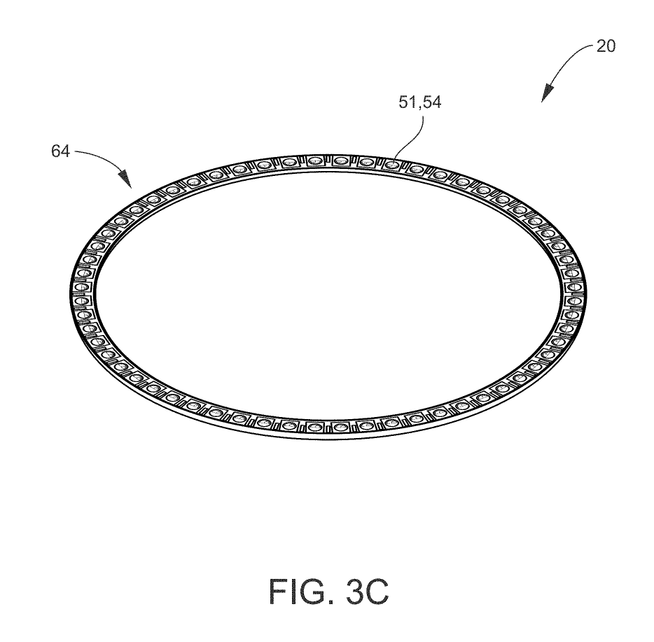

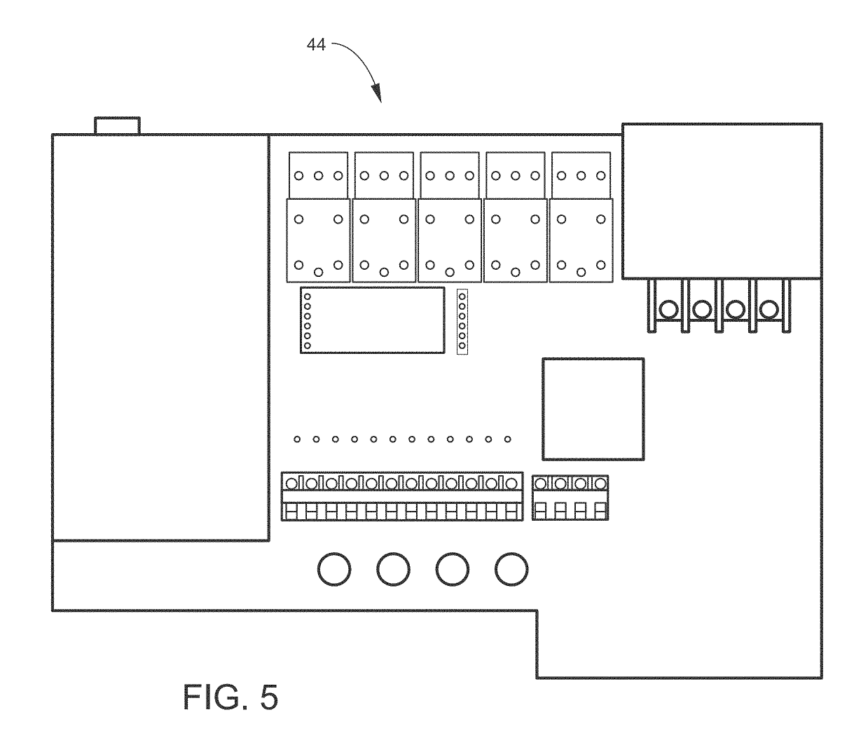

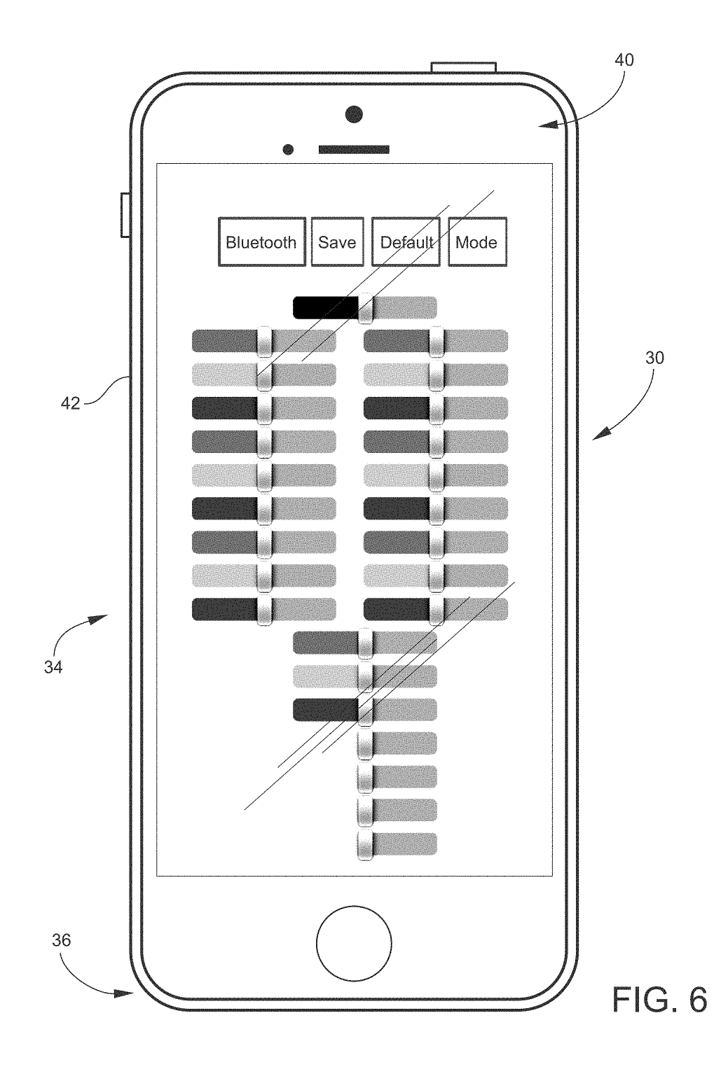

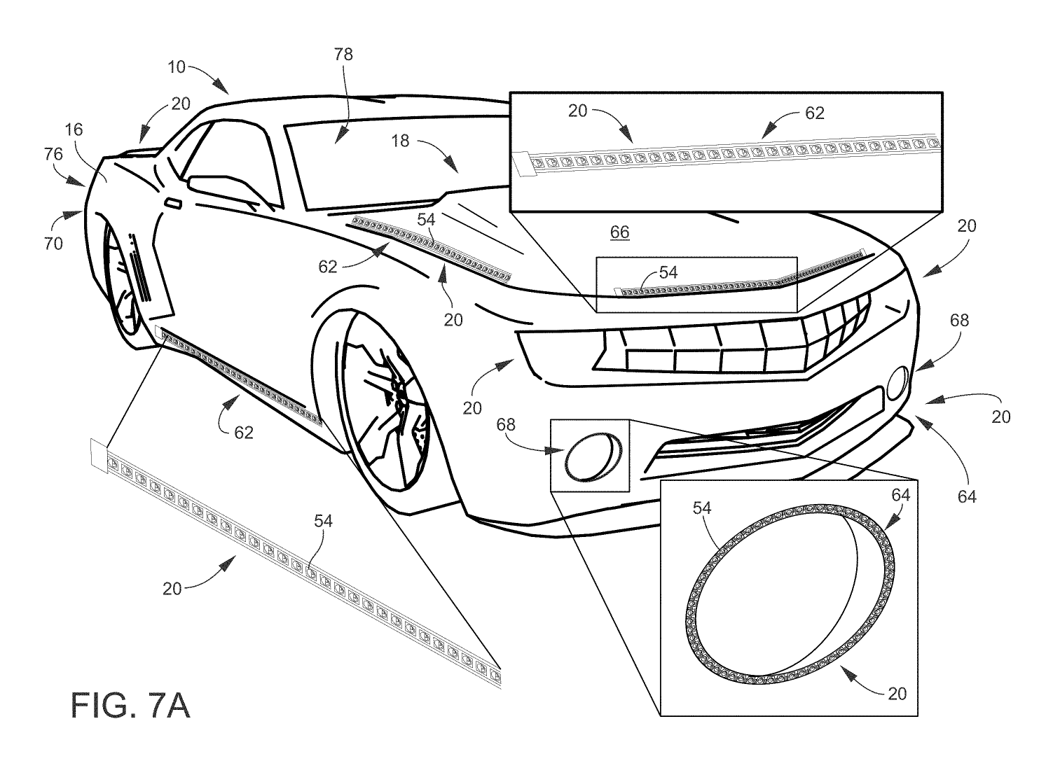

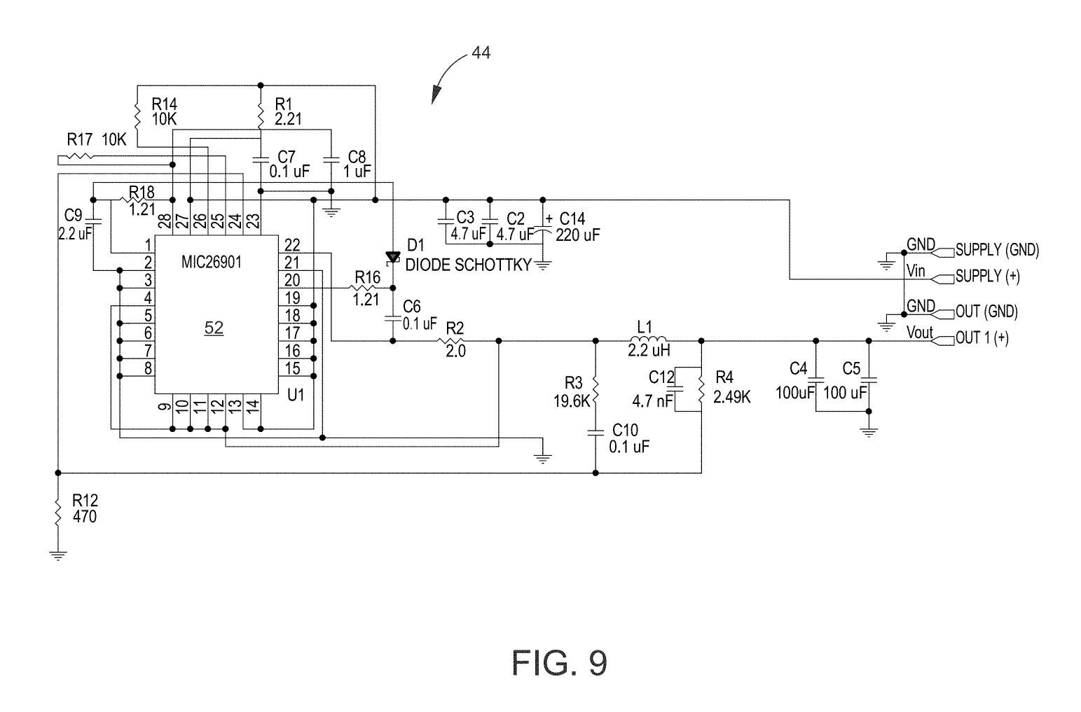

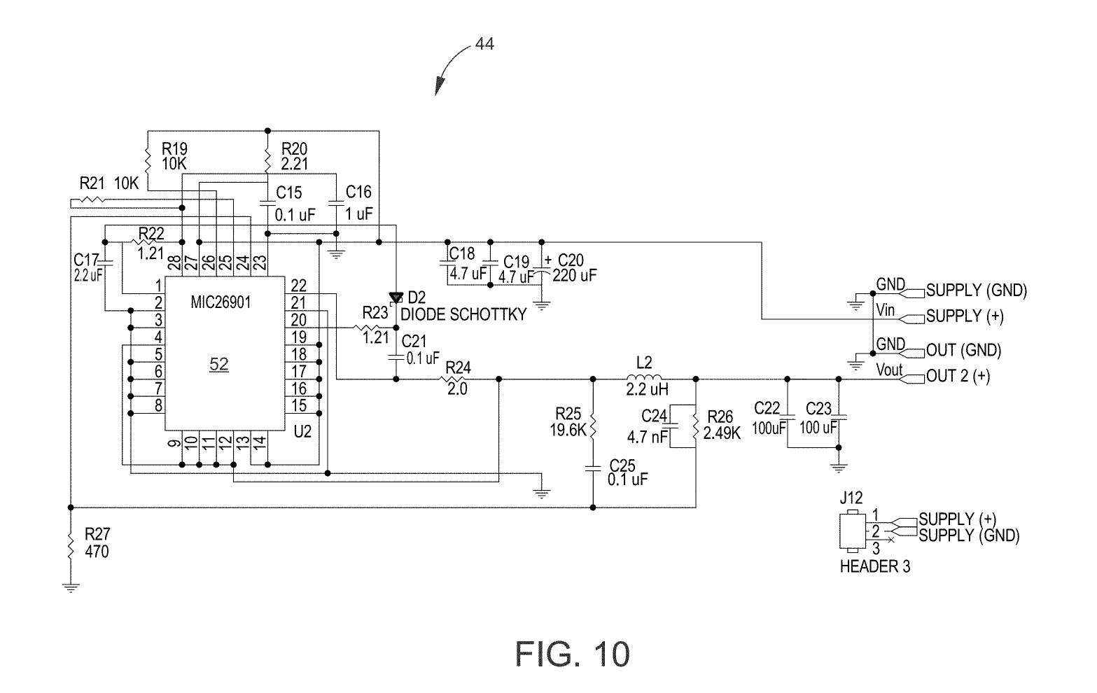

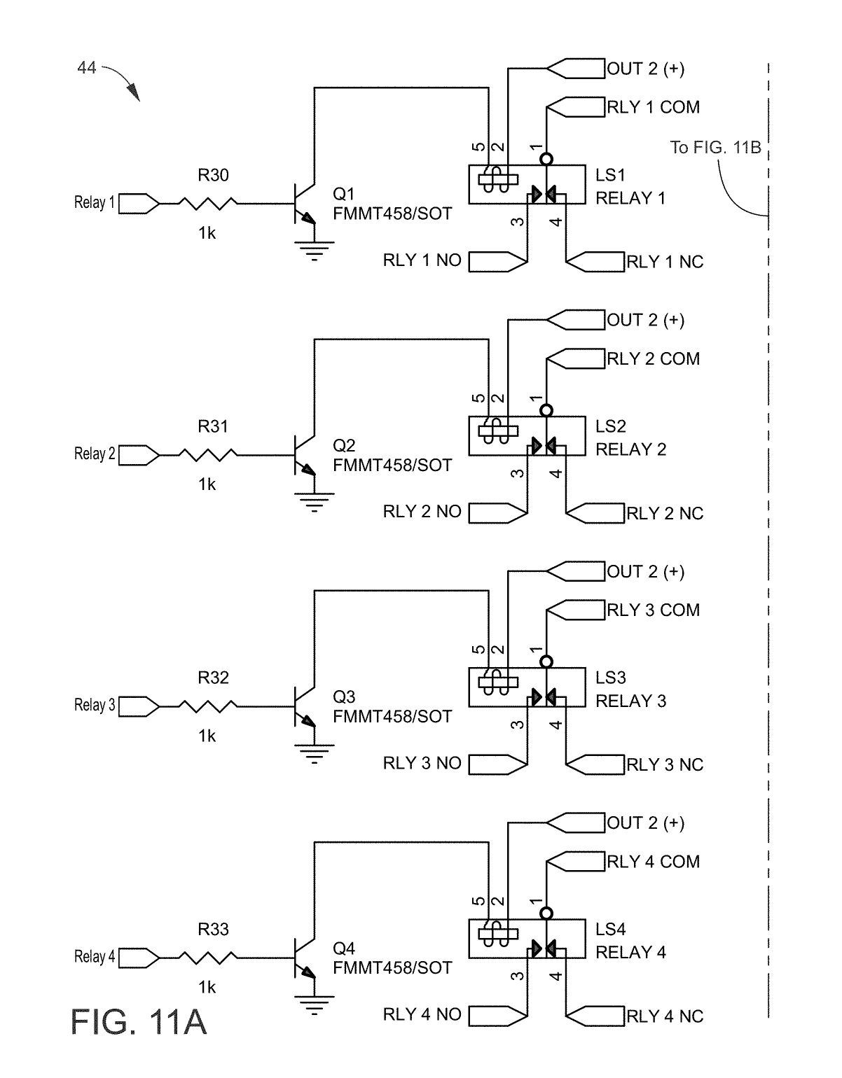

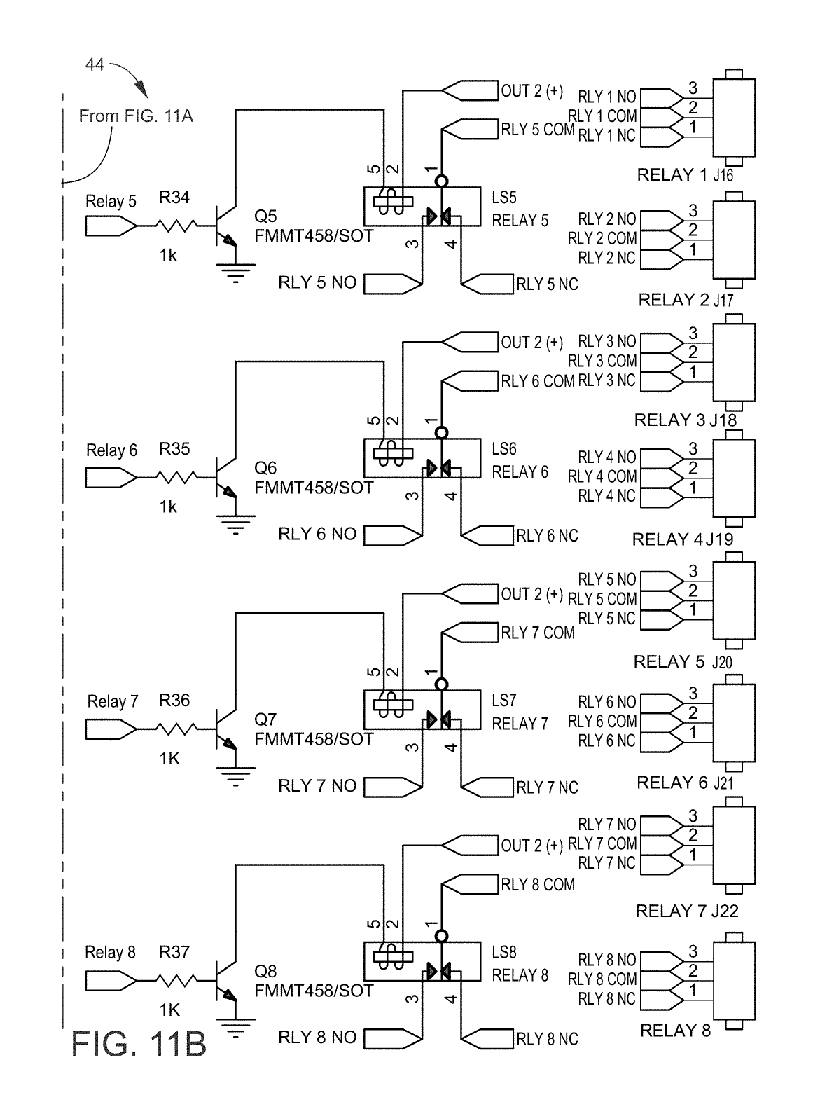

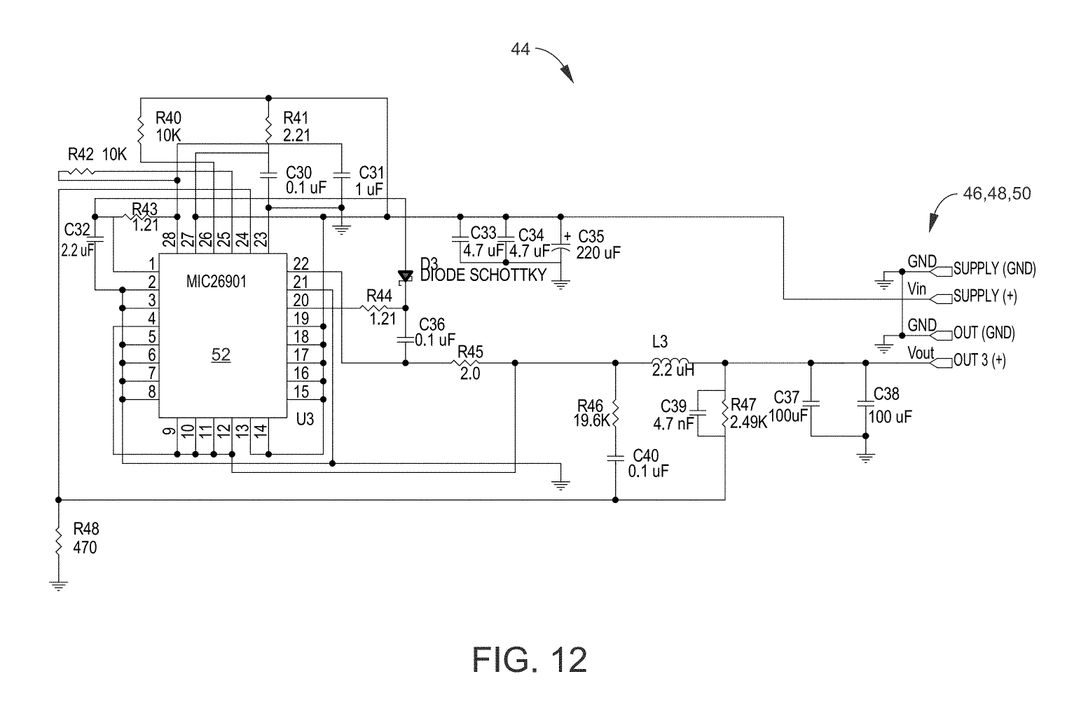

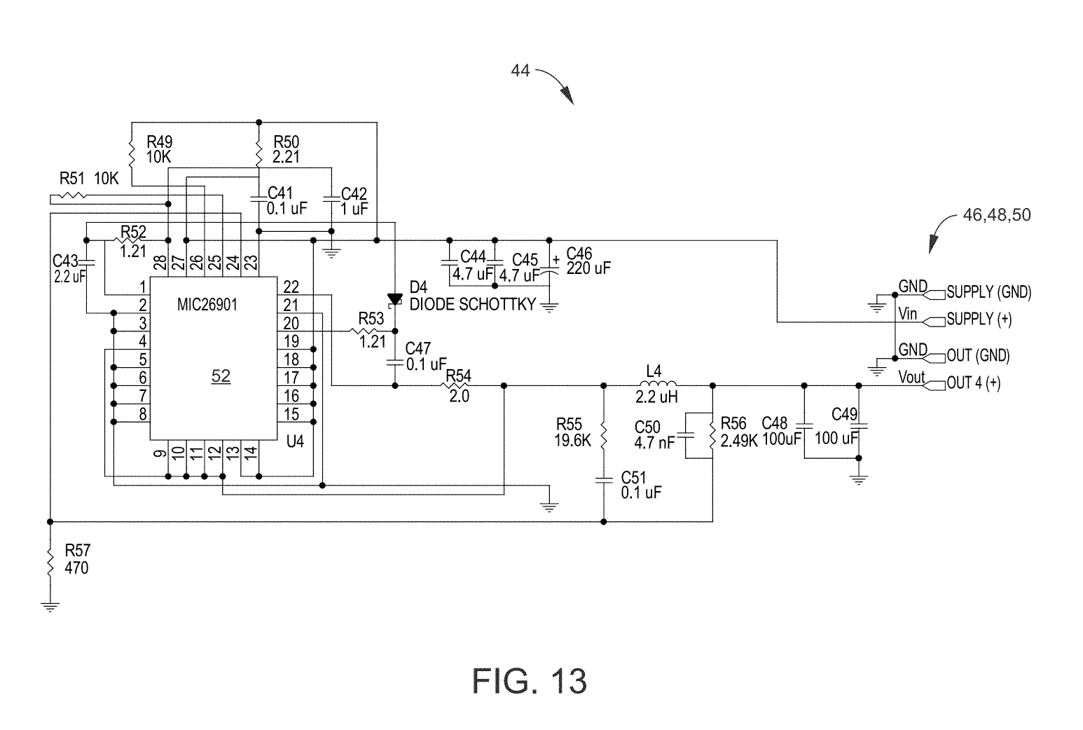

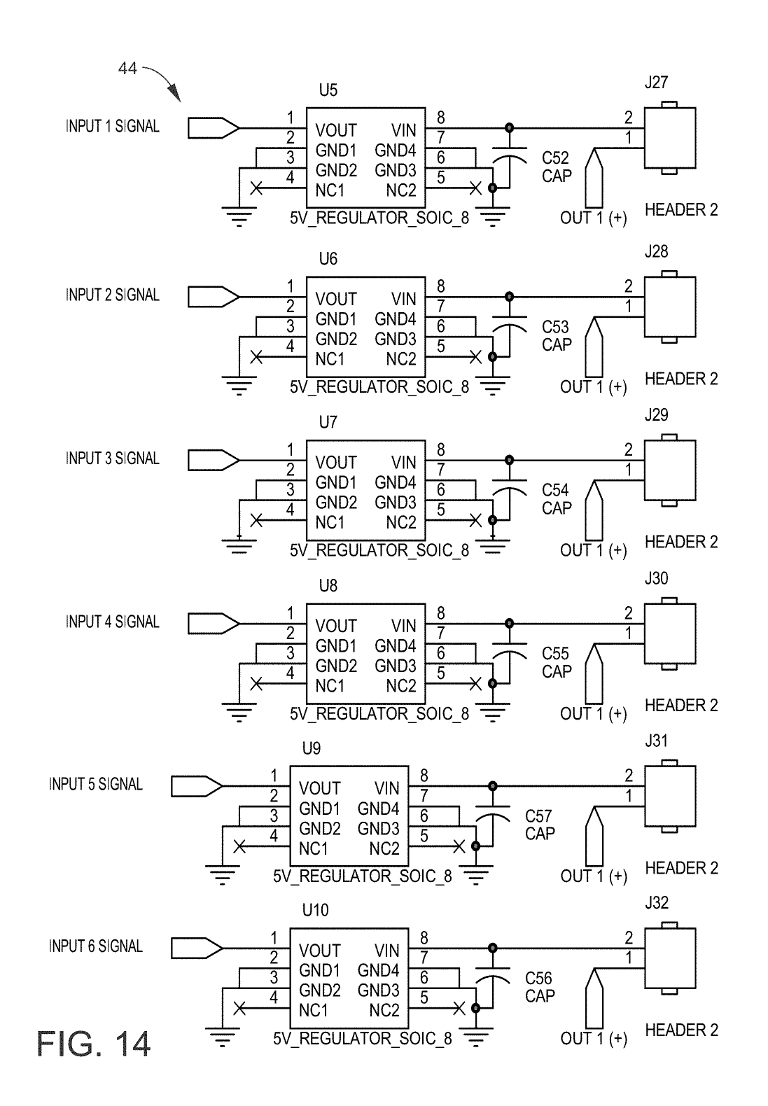

Referring now to FIGS. 1-15, in describing the exemplary embodiments of the present disclosure, specific terminology is employed for the sake of clarity. The present disclosure, however, is not intended to be limited to the specific terminology so selected, and it is to be understood that each specific element includes all technical equivalents that operate in a similar manner to accomplish similar functions. Embodiments of the claims may, however, be embodied in many different forms and should not be construed to be limited to the embodiments set forth herein. The examples set forth herein are non-limiting examples and are merely examples among other possible examples.

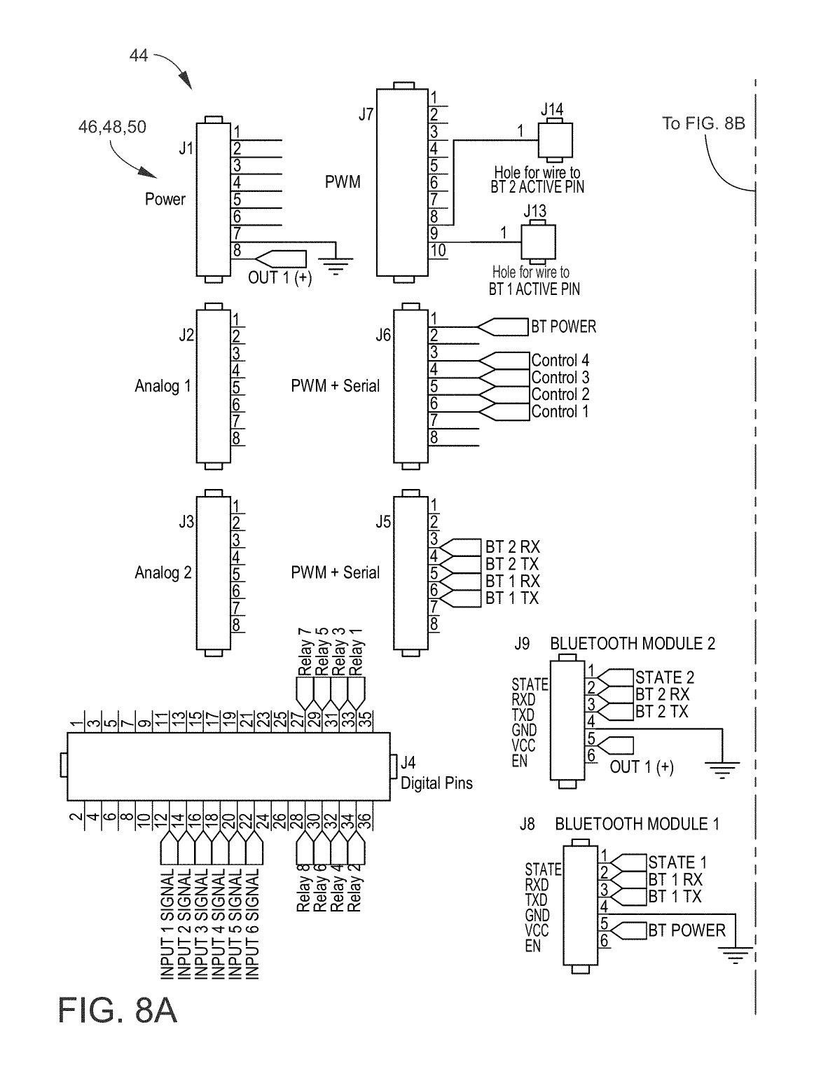

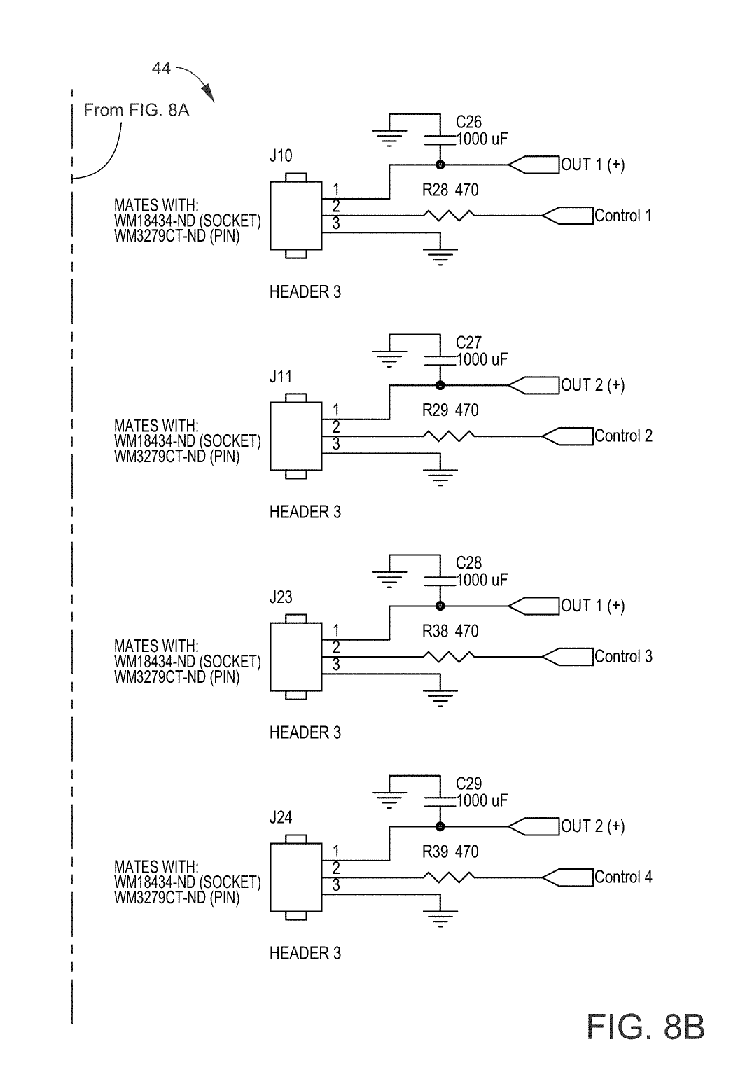

Referring now to FIGS. 1-14, in a possibly preferred embodiment, the present disclosure overcomes the above-mentioned disadvantages and meets the recognized need for such an apparatus or method by providing of OBD sensor controlled reactive system 10. As shown in FIG. 1, OBD sensor controlled reactive system 10 may generally include vehicle communication device 12, and reactive device 20. In select embodiments, as shown in the Figures, the vehicle communication device 12 may include an OBD serial communication device configured to read vehicle parameters 14 of vehicle 16 from OBD port 18 of vehicle 16 (see FIGS. 7A and 7B). Although the description and drawings may be directed to this OBD serial communication device embodiment, the disclosure is not so limited. In other embodiments, the vehicle communication device may include a direct link (not shown in the Figures) configured to read the vehicle parameters directly from the on-board computer of vehicle 16. The OBD port 18 shown in FIG. 1 may be a Type A female connector. However, as one skilled in the art should clearly understand, the disclosure is not so limited and any other OBD ports may be used, including, but not limited to, a Type B female connector. The vehicle parameters 14 read by the vehicle communication device 12 through OBD port 18 may include any vehicle parameters available through OBD port 18 including any current vehicle parameters or later discovered vehicle parameters available through OBD port 18. Vehicle parameters 14 may be real-time parameters of vehicle 16. As shown in FIG. 1, the vehicle parameters 14 read by the vehicle communication device 12 through OBD port 18 may include, but are clearly not limited thereto, engine rpm 56, temperature 58, and/or vehicle speed 60. The reactive device 20 may be in communication with the vehicle communication device 12. The reactive device 20 may be configured to process data 22 of the read vehicle parameters 14 of vehicle 16 from the vehicle communication device 12. Wherein, reactive device 20 may be configured to be controlled by the processed data 22 from the read vehicle parameters 14 of the vehicle 16 from the vehicle communication device 12 from the OBD port 18 of the vehicle 16. Accordingly, in select embodiments, and clearly not limited thereto, as shown in FIG. 1, the reactive device 20 may be configured to be controlled by the engine rpm 56, the temperature 58, and/or the vehicle speed 60.

Although the instant disclosure may be described and shown in the Figures as controlling lights with the OBD port 18, the disclosure is clearly not limited thereto, and any other electrical or mechanical devices in or on vehicle 16 may be controlled or programmed to be reactive to vehicle parameters 14 of vehicle 16 from the vehicle communication device 12. As examples, and clearly not limited thereto, the windows, door locks, auxiliary ports, radios, seats, heating, air conditioning, the like, etc. may be controlled with the instant OBD sensor controlled reactive system 10. In other words, reactive device 20 may be any device or mechanism in, on, or around vehicle 16 controlled by OBD port 18 of the vehicle

First digital communication device 24 and second digital communication device 26 may be included in select embodiments of OBD sensor controlled reactive system 10. See FIG. 1. The first digital communication device 24 may be included with vehicle communication device 12. The second digital communication device 26 may be included with the reactive device 20. The first digital communication device 24 may be configured to communication with the second digital communication device 26. Wherein, the reactive device 20 may be configured to be controlled by the processed data 22 of the read vehicle parameters 14 of the vehicle 16 from the vehicle communication device 12 from the OBD port 18 of the vehicle 16 via communication between the first digital communication device 24 and the second digital communication device 26. In select embodiments, the first digital communication device 24 may be configured to communicate wirelessly with the second digital communication device 26 via first wireless communication 28. First wireless communication 28 between first digital communication device 24 and second digital communication device 26 may be any wired or wireless communication capable of communicating the processed data 22 of the read vehicle parameters 14 of the vehicle 16 from the vehicle communication device 12 from the OBD port 18 of the vehicle 16, including any presently known or future developments of wired or wireless communication. As an example, and clearly not limited thereto, the first digital communication device 24 may be configured to communicate wirelessly with the second digital communication device 26, where the first wireless communication 28 may be short-wavelength UHF radio waves in the ISM band from 2.4 to 2.485 GHz (i.e. Bluetooth® wireless communication). vehicle communication device 12 may be any standard OBD or OBD-II serial communication device with or without Bluetooth®. As merely an example, and clearly not limited thereto, the vehicle communication device 12 may be the BlueDriver Bluetooth Professional OBDII Scan Tool for iPhone®, iPad® & Android® provided by Lemur Vehicle Monitors of Canada.

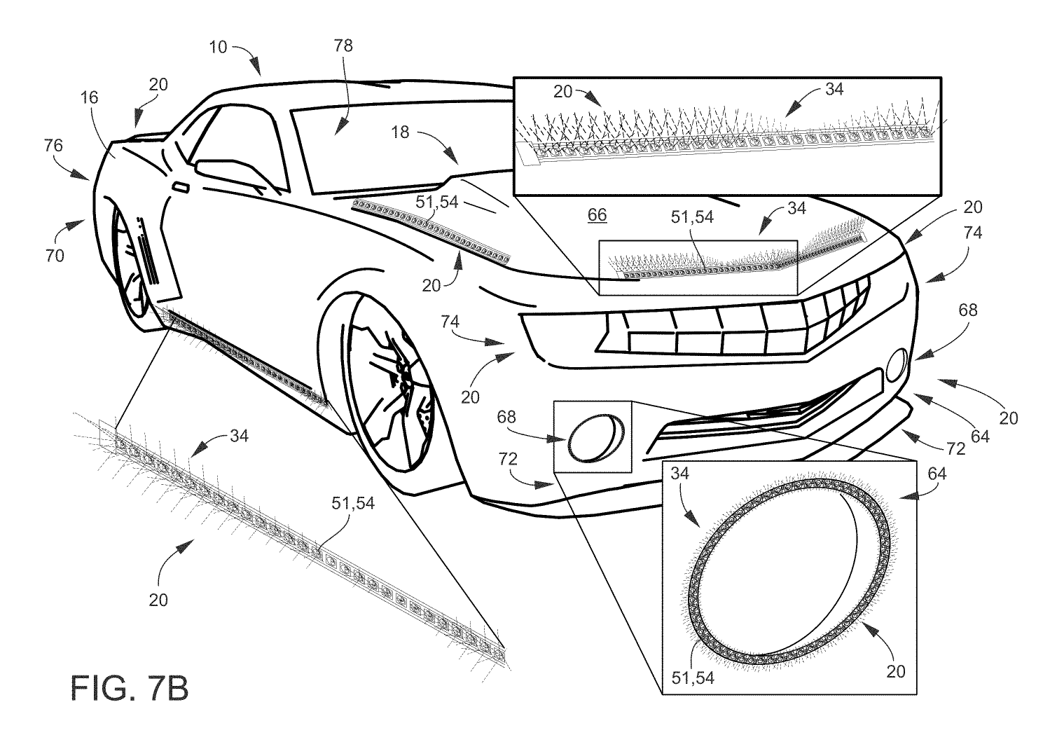

Referring now to FIGS. 1 and 6, user interface 30 may be optionally included as one feature of OBD sensor controlled reactive system 10. User interface 30 may be configured to allow a user to program the reactive device 20 to be configured to be reactive with various patterns 34 based on the processed data 22 of the various read vehicle parameters 14 of the vehicle 16 from the vehicle communication device 12 from the OBD port 18 of the vehicle 16. User interface 30 may include third digital communication device 36. This third digital communication device 36 may be configured to communicate with reactive device 20. Third digital communication device 36 may be configured for programming the reactive device 20. In select embodiments, the third digital communication device 36 may be configured to communicate wirelessly with the second digital communication device 26 of the reactive device 20 via second wireless communication 38. Second wireless communication 38 between third digital communication device 36 and second digital communication device 26 may be any wired or wireless communication capable of programming the reactive device 20 from user interface 30, including any presently known or future developments of wired or wireless communication. As an example, and clearly not limited thereto, the third digital communication device 36 may be configured to communicate wirelessly with the second digital communication device 26 via second wireless communication 38, where the second wireless communication 38 may be short-wavelength UHF radio waves in the ISM band from 2.4 to 2.485 GHz (i.e. Bluetooth® wireless communication).

Still referring to FIGS. 1 and 6, mobile application 40 may be included as feature of user interface 30 of OBD sensor controlled reactive system 10. Mobile application 40 may be configured to be operated on mobile device 42. Wherein, third digital communication device 36 may be mobile device 42 or built into mobile device 42. As shown in FIG. 6, user interface 30 provided on mobile application 40 may include various inputs for connecting the wireless connection (Bluetooth), for saving the desired pattern 34 of the reactive device 20, a default input, a mode input for changing through various modes (vehicle parameters 14) or saved patterns 34, and a plurality of slide inputs for controlling the colors and/or timing of each light from reactive device 20 based on the mode selected.

Referring now to FIGS. 1, 5 and 8-14, circuit board 44 may be included with reactive device 20 of OBD sensor controlled reactive system 10. Circuit board 44 may be built into reactive device 20 or it may be external to reactive device 20, as shown in the Figures. Circuit board 44 of reactive device 20 may be configured for controlling lights 51 of reactive device 20 based on the processed data 22 of the read vehicle parameters 14 of the vehicle 16 from the vehicle communication device 12 from the OBD port 18 of the vehicle 16. In select embodiments, circuit board 44 may include power regulator 46 configured to power the lights 51 of the reactive device 20. As examples, and clearly not limited thereto, power regulator 46 may include wired power source 48 for direct wiring to the battery or DC power source of vehicle 16, and/or battery power source 50 for an independent battery or power source for powering reactive device 20. Micro-controller 52 may be included in circuit board 44. Micro-controller 52 may be configured to control the lights 51 of the reactive device 20. Micro-controller 52 may be configured to be programmed by user interface 30.

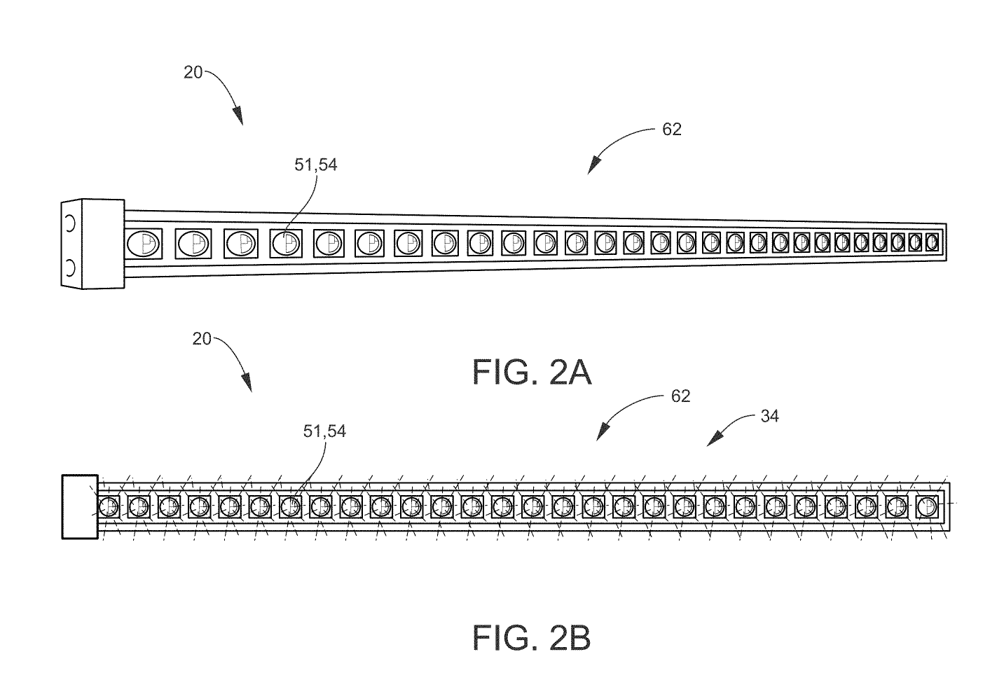

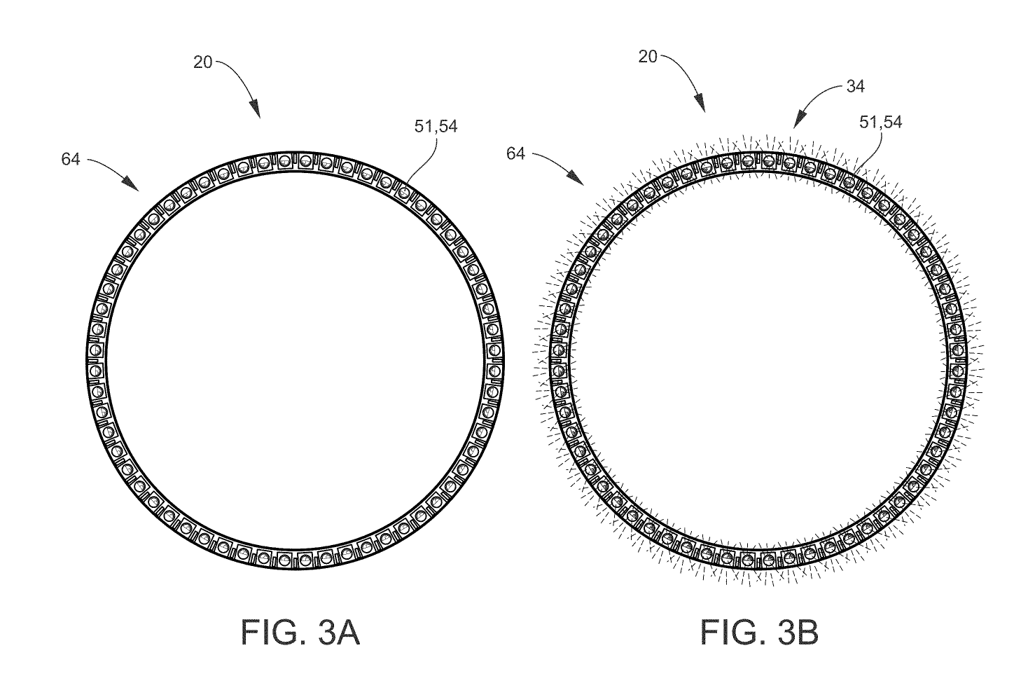

Referring now to FIGS. 1, 2A, 2B, 3A, 3B, 3C, 7A and 7B, reactive device 20 used in OBD sensor controlled reactive system 10 may be provided in many different forms and variations. As an example, and clearly not limited thereto, the lights 51 of the reactive device 20 may include light emitting diode lights 54. As shown in FIGS. 2A, 2B, 7A and 7B, in select embodiments of the OBD sensor controlled reactive system 10, the reactive device 20 may be, but clearly not limited thereto, strip LED 62. Strip LED 62 may be configured to be controlled by, or to react based upon, any of vehicle parameters 14 read from OBD port 18 of vehicle 16 via vehicle communication device 12, including, but not limited to, engine rpm 56, temperature 58, and/or vehicle speed 60. As shown in FIGS. 1, 3A, 3B, 3C, 7A and 7B, in select embodiments of the OBD sensor controlled reactive system 10, the reactive device 20 may be, but is clearly not limited thereto, halo LED 64. Halo LED 64 may be configured to be controlled by, or to react based upon, any of vehicle parameters 14 read from OBD port 18 of vehicle 16 via vehicle communication device 12, including, but not limited to, engine rpm 56, temperature 58, and/or vehicle speed 60.

Referring now specifically to FIGS. 7A and 7B, in select embodiments of the OBD sensor controlled reactive system 10, the reactive device 20 may include strip LED 62 positioned around hood 66 of vehicle 16. For aesthetic appearances, strip LED 62 positioned around hood 66 may be configured to be controlled by, or to react based upon, any of vehicle parameters 14 read from OBD port 18 of vehicle 16 via vehicle communication device 12, including, but not limited to, engine rpm 56, temperature 58, and/or vehicle speed 60. As an example, strip LED 62 positioned around hood 66 may be configured to react to engine rpm 56, whereby, when the engine is revved, strip LED 62 may light up based upon the revving of the engine. In select embodiments of the OBD sensor controlled reactive system 10, the reactive device 20 may include halo LED 64 positioned around headlights 68 of vehicle 16. Headlights 68 may be configured to be controlled by, or to react based upon, any of vehicle parameters 14 read from OBD port 18 of vehicle 16 via vehicle communication device 12, including, but not limited to, engine rpm 56, temperature 58, and/or vehicle speed 60. In select embodiments of the OBD sensor controlled reactive system 10, the reactive device 20 may include brake lights 70. Brake lights 70 may be configured to be controlled by, or to react based upon, any of vehicle parameters 14 read from OBD port 18 of vehicle 16 via vehicle communication device 12, including, but not limited to, engine rpm 56, temperature 58, and/or vehicle speed 60. In a possibly preferred safety embodiment, the brake lights 70 may be configured to be controlled by the vehicle speed 60 so that the brake lights 70 will light up when the vehicle slows down, regardless of whether or not the brakes are actually pressed. This safety embodiment may include brake lights 70 lighting brighter or more intense based upon greater decreases in speed. In select embodiments of the OBD sensor controlled reactive system 10, the reactive device 20 may include reverse lights 76. Reverse lights 76 may be configured to be controlled by, or to react based upon, any of vehicle parameters 14 read from OBD port 18 of vehicle 16 via vehicle communication device 12, including, but not limited to, engine rpm 56, temperature 58, and/or vehicle speed 60. In a possibly preferred safety embodiment, the reverse lights 76 may be configured to be controlled by the vehicle speed 60 so that the reverse lights 76 will light up when the vehicle goes in reverse, regardless of whether or not the gear of the vehicle is in the reverse position (like on a hill). In select embodiments of the OBD sensor controlled reactive system 10, the reactive device 20 may include headlights 68 of the vehicle 16. Headlights 68 may be configured to be controlled by, or to react based upon, any of vehicle parameters 14 read from OBD port 18 of vehicle 16 via vehicle communication device 12, including, but not limited to, engine rpm 56, temperature 58, and/or vehicle speed 60. In select embodiments of the OBD sensor controlled reactive system 10, the reactive device 20 may include fog lights 72 of the vehicle 16. Fog lights 72 may be configured to be controlled by, or to react based upon, any of vehicle parameters 14 read from OBD port 18 of vehicle 16 via vehicle communication device 12, including, but not limited to, engine rpm 56, temperature 58, and/or vehicle speed 60. In select embodiments of the OBD sensor controlled reactive system 10, the reactive device 20 may include signal lights 74 of the vehicle 16. Signal lights 74 may be configured to be controlled by, or to react based upon, any of vehicle parameters 14 read from OBD port 18 of vehicle 16 via vehicle communication device 12, including, but not limited to, engine rpm 56, temperature 58, and/or vehicle speed 60. In select embodiments of the OBD sensor controlled reactive system 10, the reactive device 20 may include interior lights 78 positioned inside the vehicle 16. Interior lights 78 of vehicle 16 may be configured to be controlled by, or to react based upon, any of vehicle parameters 14 read from OBD port 18 of vehicle 16 via vehicle communication device 12, including, but not limited to, engine rpm 56, temperature 58, and/or vehicle speed 60.

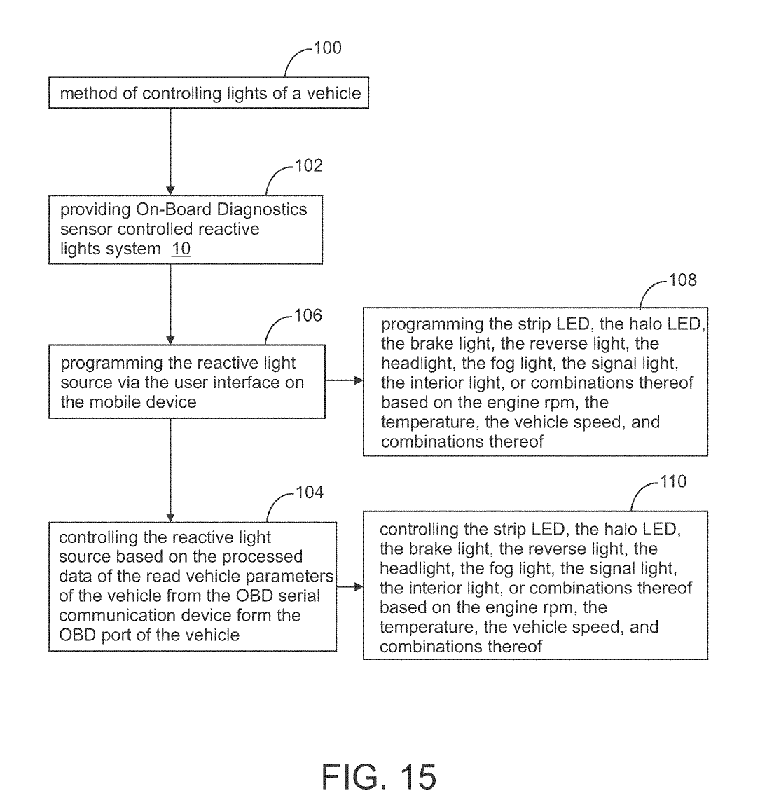

Referring now to FIG. 15, in another aspect, the instant disclosure embraces method 100 of controlling lights 51 of vehicle 16 based on the instant on-board diagnostics sensor controlled reactive system 10. Accordingly, method 100 of controlling lights 51 of vehicle 16 may include step 102 of providing the instant on-board diagnostics sensor controlled reactive system 10 in any of the various embodiments shown and/or described herein. As such, the OBD sensor controlled reactive system 10 provided in method 100 of controlling lights 51 of vehicle 16 may generally include the vehicle communication device 12 configured to read vehicle parameters 14 of vehicle 16 from the OBD port 18 of the vehicle 16, and the reactive device 20 may be in communication with the vehicle communication device 12, where the reactive device 20 may be configured to process data 22 of the read vehicle parameters 14 of the vehicle 16 from the vehicle communication device 12. Method 100 of controlling lights 51 of vehicle 16 based on the instant on-board diagnostics sensor controlled reactive system 10 may then include step 104 of controlling the reactive device 20 based on the processed data 22 of the read vehicle parameters 14 of the vehicle 16 from the vehicle communication device 12 from the OBD port 18 of the vehicle 16. In select embodiments of method 100 of controlling lights 51 of vehicle 16 based on the instant on-board diagnostics sensor controlled reactive system 10, when the OBD sensor controlled reactive system 10 includes user interface 30, where user interface 30 is configured to allow a user to program the reactive device 20 to be configured to be reactive with various patterns 34 based on the processed data 22 of the various read vehicle parameters 14 of the vehicle 16 from the vehicle communication device 12 from the OBD port 18 of the vehicle 16, wherein the user interface 30 includes third digital communication device 36 configured to communicate with the reactive device 20 configured for programming the reactive device 20, wherein the third digital communication device 36 is configured to communicate wirelessly with the second digital communication device 26 of the reactive device 20, and wherein the user interface 30 includes mobile application 40 configured to be operated on mobile device 42, wherein the third digital communication device 36 is in or is the mobile device 42, method 100 may further include step 106 of programming the reactive device 20 via user interface 30 on mobile device 42. In select embodiments, method 100 of controlling lights 51 of vehicle 16 may include the steps of: step 108 of programming strip LED 62, halo LED 64, brake light 70, reverse light 76, headlight 68, fog light 72, signal light 74, interior light 78, or combinations thereof based on engine rpm 56, temperature 58, vehicle speed 60, and combinations thereof; and step 110 of controlling strip LED 62, halo LED 64, brake light 70, reverse light 76, headlight 68, fog light 72, signal light 74, interior light 78, or combinations thereof based on engine rpm 56, temperature 58, vehicle speed 60, and combinations thereof.

In sum, the instant OBD sensor controlled reactive system 10 and method 100 of controlling vehicle lights may be designed or provided to control lights 51 in and around vehicle 16 based off vehicle parameters 14 and provide optional patterns 34 in lights 51 via the OBDII port 18 of the vehicle 16. As examples, and clearly not limited thereto, the engine rpm 56, temperature 58, and vehicle mph 60 may be used to control the color, brightness, and or gradient of LEDs and other OEM and aftermarket lighting in and around vehicle 16.

Vehicle 16 may include mechanical and electrical components of which are controlled by an on-board computer. The on-board computer is accessed via OBD port 18. Lights 51 contained in or around vehicle 16 may be controlled via system 10 that processes data 22 acquired from the OBD port 18. Therefore, multiple lighting scenarios can be programmed to assist in both vehicle safety and cosmetic routines. As examples, and clearly not limited thereto, system 10 may be utilized to control brake lights when a vehicle decelerates without the brake pedal being depressed. This can include both rapid and slow deceleration with unique routines or patterns 34 for each situation. Cosmetic routines include but are not limited to LED strips that change color or length of illumination and patterns 34 that can be placed in and around the vehicle, like for car shows or other desired uses. For example, strip LED 62 may be placed around hood 66 of vehicle 16, where strip LED 62 may be designed with patterns 34 that illuminate as the vehicle RPM increases and decreases.

A feature of the present disclosure may be its ability to display engine rpm 56 through reactive lighting. And any other vehicle/engine specifics transmitted or communicated through the OBD port 18. Another feature of the present disclosure may be its ability to display engine temperature 58 through reactive lighting. This feature may allow a vehicle to notify a user when the temperature 58 reaches a certain temperature (like for remote start of a vehicle in cold conditions). Another feature of the present disclosure is its ability to turn on brake lights when the vehicle begins to slow down due to an external or internal force other than the brakes with or without interaction from the operator of the vehicle or passengers. (the brake lights in-turn will become “deceleration lights”)

In the specification and/or figures, typical embodiments of the disclosure have been disclosed. The present disclosure is not limited to such exemplary embodiments. The use of the term “and/or” includes any and all combinations of one or more of the associated listed items. The figures are schematic representations and so are not necessarily drawn to scale. Unless otherwise noted, specific terms have been used in a generic and descriptive sense and not for purposes of limitation.

The foregoing description and drawings comprise illustrative embodiments. Having thus described exemplary embodiments, it should be noted by those skilled in the art that the within disclosures are exemplary only, and that various other alternatives, adaptations, and modifications may be made within the scope of the present disclosure. Merely listing or numbering the steps of a method in a certain order does not constitute any limitation on the order of the steps of that method. Many modifications and other embodiments will come to mind to one skilled in the art to which this disclosure pertains having the benefit of the teachings presented in the foregoing descriptions and the associated drawings. Although specific terms may be employed herein, they are used in a generic and descriptive sense only and not for purposes of limitation. Accordingly, the present disclosure is not limited to the specific embodiments illustrated herein but is limited only by the following claims.

1. An On-Board Diagnostics sensor controlled reactive system comprising:
a vehicle communication device configured to read vehicle parameters of a vehicle; and
a reactive device in communication with the vehicle communication device;
said reactive device is configured to process data from the read vehicle parameters of the vehicle from the vehicle communication device;
wherein, said reactive device is configured to be controlled by processed data of the read vehicle parameters of the vehicle from the vehicle communication device.

2. The On-Board Diagnostics sensor controlled reactive system of claim 1, wherein the vehicle communication device includes:
an OBD serial communication device configured to read the vehicle parameters from the OBD port of the vehicle; or
a direct link configured to read the vehicle parameters directly from an on-board computer of the vehicle.

3. The On-Board Diagnostics sensor controlled reactive system of claim 1 further including:
a first digital communication device in said vehicle communication device; and
a second digital communication device in said reactive device;
said first digital communication device is configured to communication with the second digital communication device;
wherein, said reactive device is configured to be controlled by the processed data of the read vehicle parameters of the vehicle from the vehicle communication device via communication between the first digital communication device and the second digital communication device.

4. The On-Board Diagnostics sensor controlled reactive system of claim 3, wherein said first digital communication device is configured to communicate wirelessly with the second digital communication device via a first wireless communication.

5. The On-Board Diagnostics sensor controlled reactive system of claim 4, wherein the first wireless communication being short-wavelength UHF radio waves in the ISM band from 2.4 to 2.485 GHz.

6. The On-Board Diagnostics sensor controlled reactive system of claim 1 further comprising a user interface, said user interface is configured to allow a user to program the reactive device to be configured to be reactive with various patterns based on the processed data of the various read vehicle parameters of the vehicle from the vehicle communication device, wherein the user interface includes a third digital communication device configured to communicate with the reactive device configured for programming the reactive device.

7. The On-Board Diagnostics sensor controlled reactive system of claim 6, wherein said third digital communication device is configured to communicate wirelessly with a second digital communication device of the reactive device via a second wireless communication.

8. The On-Board Diagnostics sensor controlled reactive system of claim 7, wherein the second wireless communication being short-wavelength UHF radio waves in the ISM band from 2.4 to 2.485 GHz.

9. The On-Board Diagnostics sensor controlled reactive system of claim 6, wherein said user interface includes a mobile application configured to be operated on a mobile device, wherein the third digital communication device is included in the mobile device.

10. The On-Board Diagnostics sensor controlled reactive system of claim 1, wherein the reactive device including a circuit board configured for controlling lights of the reactive device based on the processed data of the read vehicle parameters of the vehicle from the vehicle communication device.

11. The On-Board Diagnostics sensor controlled reactive system of claim 10, wherein the circuit board including a power regulator configured to power the lights of the reactive device.

12. The On-Board Diagnostics sensor controlled reactive system of claim 11, wherein the power regulator including a wired power source or a battery power source.

13. The On-Board Diagnostics sensor controlled reactive system of claim 10, wherein the circuit board including a micro-controller configured to control the lights of the reactive device.

14. The On-Board Diagnostics sensor controlled reactive system of claim 10, wherein the lights of the reactive device include light emitting diode lights.

15. The On-Board Diagnostics sensor controlled reactive system of claim 1, wherein the vehicle parameters read by the vehicle communication device include:
an engine rpm;
a temperature; a vehicle speed; or
combinations thereof;
wherein, said reactive device is configured to be controlled by the engine rpm, the temperature, the vehicle speed, or combinations thereof.

16. The On-Board Diagnostics sensor controlled reactive system of claim 15, wherein:
the reactive device is a strip LED configured to be controlled by the engine rpm, the temperature, the vehicle speed, or combinations thereof;
the reactive device is a halo LED configured to be controlled by the engine rpm, the temperature, the vehicle speed, or combinations thereof;
the reactive device is the strip LED positioned around a hood of the vehicle configured to be controlled by the engine rpm, the temperature, the vehicle speed, or combinations thereof;
the reactive device is the halo LED positioned around headlights of the vehicle and configured to be controlled by the engine rpm, the temperature, the vehicle speed, or combinations thereof;
the reactive device is brake lights configured to be controlled by the vehicle speed, where the brake lights react when the vehicle speed decreases;
the reactive device is headlights configured to be controlled by the engine rpm, the temperature, the vehicle speed, or combinations thereof;
the reactive device is fog lights configured to be controlled by the engine rpm, the temperature, the vehicle speed, or combinations thereof;
the reactive device is signal lights configured to be controlled by the engine rpm, the temperature, the vehicle speed, or combinations thereof;
the reactive device is reverse lights configured to be controlled by the vehicle speed, where the reverse lights react when the vehicle speed is negative;
the reactive device is interior lights positioned inside the vehicle and configured to be controlled by the engine rpm, the temperature, the vehicle speed, or combinations thereof;
or combinations thereof.

17. An On-Board Diagnostics sensor controlled reactive system comprising:
a vehicle communication device configured to read vehicle parameters of a vehicle from an OBD port of the vehicle or from a direct link to the on-board computer of the vehicle, said vehicle communication device including a first digital communication device; and
a reactive device including light emitting diodes and in communication with the vehicle communication device, said reactive device including a second digital communication device and a circuit board;
said reactive device is configured to process data of the read vehicle parameters of the vehicle from the vehicle communication device;
wherein said first digital communication device is configured to communicate wirelessly with the second digital communication device;
wherein, said reactive device is configured to be wirelessly controlled by processed data of the read vehicle parameters of the vehicle from the vehicle communication device via wireless communication between the first digital communication device and the second digital communication device; and
a user interface, said user interface is configured to allow a user to program the reactive device to be configured to be reactive based on the processed data of the read vehicle parameters of the vehicle from the vehicle communication device, the user interface includes a third digital communication device configured to communicate with the reactive device;
wherein said third digital communication device is configured to communicate wirelessly with the second digital communication device of the reactive device;
wherein said user interface includes a mobile application configured to be operated on a mobile device, wherein the third digital communication device is the mobile device;
wherein the circuit board is configured for controlling lights of the reactive device based on the processed data of the read vehicle parameters of the vehicle from the vehicle communication device;
wherein the circuit board including a power regulator configured to power the lights of the reactive device, the power regulator including a wired power source or a battery power source;
wherein the circuit board including a micro-controller configured to control the lights of the reactive device; and
wherein the vehicle parameters read by the vehicle communication device include an engine rpm, a temperature, a vehicle speed; and combinations thereof, wherein, said reactive device is configured to be controlled by the engine rpm, the temperature, the vehicle speed, or combinations thereof.

18. A method of controlling lights of a vehicle comprising:
providing On-Board Diagnostics sensor controlled reactive system comprising:
a vehicle communication device configured to read vehicle parameters of the vehicle from an OBD port of the vehicle or from a direct link to an on-board computer of the vehicle; and
a reactive device in communication with the vehicle communication device;
said reactive device is configured to process data of the read vehicle parameters of the vehicle from the vehicle communication device;
controlling the reactive device based on processed data of the read vehicle parameters of the vehicle from the vehicle communication device.

19. The method of controlling lights of a vehicle of claim 18, wherein the On-Board Diagnostics sensor controlled reactive system further comprising:
a user interface, said user interface is configured to allow a user to program the reactive device to be configured to be reactive with various patterns based on the processed data of the various read vehicle parameters of the vehicle from the vehicle communication device, wherein the user interface includes a third digital communication device configured to communicate with the reactive device configured for programming the reactive device, wherein said third digital communication device is configured to communicate wirelessly with a second digital communication device of the reactive device, wherein said user interface includes a mobile application configured to be operated on a mobile device, wherein the third digital communication device is the mobile device;
wherein the method further including programming the reactive device via the user interface on the mobile device.

20. The method of controlling lights of a vehicle of claim 19, wherein:
programming a strip LED, a halo LED, a brake light, a reverse light, a headlight, a fog light, a signal light, an interior light, or combinations thereof, based on an engine rpm, a temperature, a vehicle speed, or combinations thereof; and
controlling the strip LED, the halo LED, the brake light, the reverse light, the headlight, the fog light, the signal light, the interior light, or combinations thereof based on the engine rpm, the temperature, the vehicle speed, or combinations thereof.
